(19) United States
(12) Patent Application Publication
(10) Pub. No.: US 2016/0005335 A1
(43) Pub. Date: Jan. 7, 2016

(54) COLOR DETECTION SYSTEM AND METHOD FOR COLOR DETECTION FOR THE VISUALLY IMPAIRED

(71) Applicant: KING FAHD UNIVERSITY OF PETROLEUM AND MINERALS, DHAHRAN (SA)

(72) Inventor: JIHAD HASSAN ALSADAH, SAFWA (SA)

(21) Appl. No.: 14/321,755

(22) Filed: Jul. 1, 2014

(51) Int. Cl. G09B 21/00

(52) U.S. Cl. CPC G09B 21/007

(57) ABSTRACT

The color detection system relates generally to an intelligent system, apparatuses and methods to aid the visually impaired. More specifically, the color detection system is a system in the field of biomedical engineering designed to help the visually impaired to experience colors through experience, training, and sensory association. The system is such that it decodes color into parameters as per a predetermined coding scheme. The parameters are then sent to the visually impaired person as biofeedback capable of taking various forms such as a voltage signals, vibration motions, auditory pitches, and pinboards. The system can be used in several ways such as and including color recognition, sensory association, painting, and color recognition exercises. The color detection system includes a control unit using sensors. The control unit has a central processing unit for processing signals and a number of output units for transmitting the biofeedback to a visually impaired individual.

### BACKGROUND OF THE INVENTION

1. Field of the Invention

The present invention relates to a color detection system. More particularly, the present invention relates to a color detection system for the visually impaired to experience colors through biofeedback such as voltage signals, vibration, auditory pitches, pinboards, and reading pins.

2. Description of the Related Art

A color detector is a type of device that is designed for use by individuals who are blind, have low or poor vision, or a visual impairment. The primary purpose of such color detectors is to identify colors and to enable the visually impaired to experience the color richness of the world. Color detectors can allow for the visually impaired to identify clothing articles, color walls, or simply appreciate art, for example.

Color detectors for blind individuals are known. Common color detectors include talking color detectors and color analyzers. Talking color detectors are color identifiers designed for use by individuals who are blind or have poor vision. The user can adjust the volume of the color detector or select more than one language for the talking color detector. Color detectors can be very useful in identifying clothing colors and objects. The device can usually also announce the shades and tints of a color as well, such as dark brown, blue-green or pale pink. The color detectors work by interpreting saturation, hue and lightness to determine the correct color.

Color analyzers work in a much the same manner as a color detector. Color analyzers generally use an optical device, such as a camera lens, to identify colors. The color analyzer can identify a color using the optical device and return the red, green and blue (RGB) components with an audio name of a color.

Also, blind individuals have been able to identify a color by Braille blocks. However, the visually impaired person typically does not receive a sensory association with a color from reading a Braille block as would a person without a visual impairment. The color detection system can assist the visually impaired to connect feelings and thoughts to a number of colors, such as producing biofeedback for the color blue to be linked with putting a hand in cold water or producing biofeedback for the color red to be linked with holding a hot rock in a hand.

There appears to be a need for a color detection system to incorporate the use of biofeedback in conjunction with user training associating the biofeedback with a number of colors as can assist the visually impaired to “see” colors by associating colors with types of biofeedback. Thus, a color detection system for the visually impaired addressing the aforementioned problems is desired.

### SUMMARY OF THE INVENTION

Embodiments of apparatuses include a color detection system and also include methods to incorporate the use of optical sensors to detect color and convert the detected color into biofeedback to assist the visually impaired to associate the detected color with a type of biofeedback. Biofeedback can also be described as sensory feedback.

Embodiments of a color detection system for the visually impaired include at least one optical sensor, at least one flexible wire, cable or a wired or wireless transmitter/receiver, and a control unit, in which the at least one optical sensor is communicatively connected by at least one flexible wire or cable or by the transmitter/receiver to the control unit to detect a color of an object. The control unit includes a memory and a central processing unit, associated with a power source, such as a battery, for example. The color detection system further includes an audio signal output unit, a vibration output unit, and a voltage output unit, for example. Embodiments of a color detection system are designed to incorporate the use of optical sensors to detect color and convert the detected color into biofeedback to assist the visually impaired to associate the detected color with a type of sensory association.

Information, such as signals of at least one color detected, can be acquired from the optical sensor and sent to the control unit. The signals regarding the color detected can be analog or digital. The converter in the control unit can transform the data signals of the color detected into a set of parameters. The converter can then send the set of parameters to the central processing unit of the control unit for processing the at least one set of parameters into a type of biofeedback or sensory feedback for the visually impaired. The central processing unit can also store the at least one set of parameters into a computer readable memory. The central processing unit can transmit the biofeedback into a number of sensory output units to assist the visually impaired to associate the color detected with a sensory output.

The color detector system implements a method of decoding color into a set of parameters as by a parametric coding scheme. Several parameters can be used to decode a color and can include: Hue, Saturation and Brightness (HSB), Hue, Saturation and Lightness (HSL), Red, Green and Blue (RGB), Cyan, Magenta and Yellow (CMY), and Cyan, Magenta, Yellow and Black (CMYK), or combinations thereof, for example.

The data signals of a color detected can be sent or converted for use to an audio signal output unit, a voltage output unit, or a vibration output unit. The data signals can be converted to and in the form of voltage signals of varying voltage level, vibrations of a varying intensity, vibrations of a varying frequency, vibrations of varying time duration, and auditory pitches of varying intensity, for example.

Embodiments of a color detection system can also have signals corresponding to colors output by pins above a surface, e.g., such as a pinboard displaying a representation of the color detected. Also, embodiments of a color detection system can also display the signal corresponding to a color detected in Braille form.

Embodiments of a color detection system can be integrally formed to include optical sensors, a converter, a central processing unit, a memory, and a number of biofeedback output units, and can also include a power source, such as battery. The biofeedback output can be in the form of voltage signals, vibrations, and audio pitches, for example. Also, embodiments of a color detection system can also be adapted for use to include olfactory senses to receive by a sense of smell a representation of a detected color.

Various embodiments of a color detection system can be implemented as apparatuses, such as a finger cover with an optical sensor attached to a control unit, a glove containing optical sensors connected by wires or a wireless transmitter/receiver to a control unit, and a pen containing an optical sensor with a control unit and a digital output unit, for example. A finger cover of a color detector apparatus in embodiments of a color detection system can also be implemented as to cover an entire finger, a finger insert including a number of straps on or around the fingertips, or a combination thereof equipped with one or more sensors or photo detectors.

Embodiments of a color detection system can also include elements for detecting one or more colors, with the one or more colors being disposed on a portable carrier. Also, the parameters and biofeedback as implemented in embodiments of a color detection system can be used to assist a visually impaired person to experience the richness of color in an object.

These and other features of the present invention will become readily apparent upon further review of the following specification and drawings.

### BRIEF DESCRIPTION OF THE DRAWINGS

FIG. 1 is a block diagram illustrating an embodiment of a color detection system including an optical sensor and a general control unit according to the present invention.

FIG. 2A is a front, palm view of an embodiment of a color detection system illustrated as a finger cover containing a number of optical sensors attached by a wire connected to a control unit according to the present invention.

FIG. 2B is a back view of an embodiment of a color detection system of FIG. 2A illustrating the finger cover containing the number of optical sensors attached by a wire connected to the control unit according to the present invention.

FIG. 3 is a front, palm view of an embodiment of a color detection system in the form a glove containing optical sensors connected by wires to a control unit according to the present invention.

FIG. 4A is an exterior view illustrating an embodiment of a color detection system in the form of a digital pen containing an optical sensor, a power switch, a number of sensory output units, and a digital output unit according to the present invention.

FIG. 4B is an interior view illustrating an embodiment of a color detection system of FIG. 4A in the form of a digital pen containing the optical sensor, a converter, a central processing unit, memories, a number of sensory output units, a battery, and a digital output unit according to the present invention.

FIG. 5 is a flowchart illustrating an embodiment of a method for color detection in a color detection system according to the present invention.

Unless otherwise indicated, similar reference characters denote corresponding features consistently throughout the attached drawings.

### DETAILED DESCRIPTION OF THE PREFERRED EMBODIMENTS

A color detection system for the visually impaired includes at least one optical sensor, at least one flexible wire, cable or a wired or wireless transmitter/receiver, and a control unit, in which the at least one optical sensor is communicatively connected by at least one flexible wire, cable or a transmitter/receiver to a control unit to detect a color of an object. The color detection system further can include an audio signal output unit, a vibration output unit, and a voltage output unit. The color detection system can take various forms in embodiments. Embodiments of a color detection system can be designed to incorporate the use of optical sensors to detect color and convert the detected color into biofeedback or sensory feedback to assist the visually impaired to associate the detected color with a type of sensory association. Biofeedback can also be described as sensory feedback.

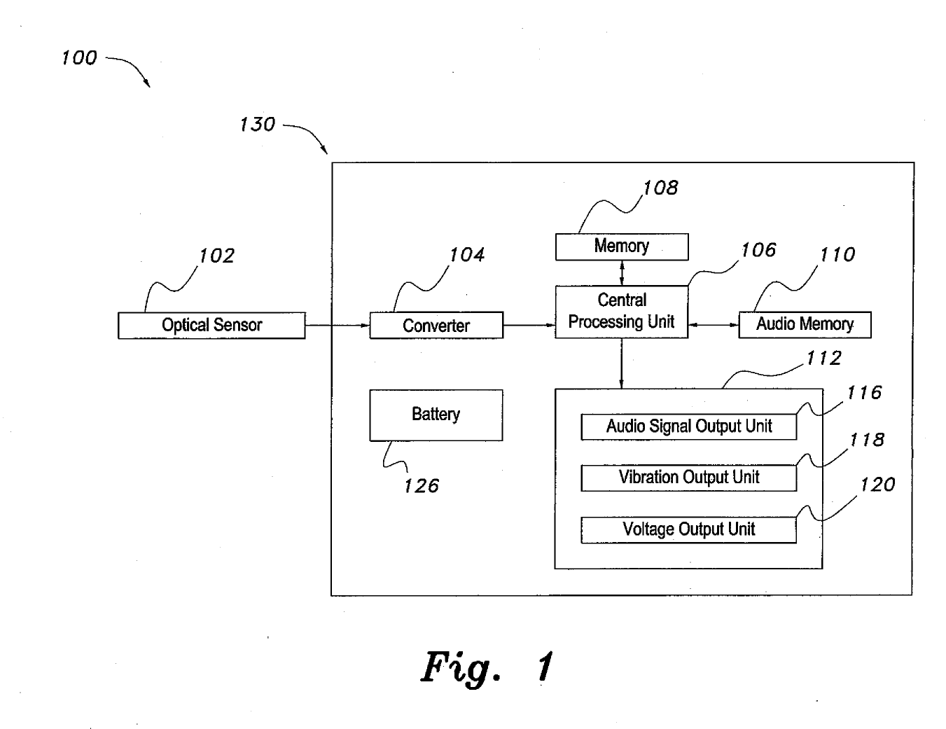

With reference now to the drawings, in particular to FIGS. 1 to 5 thereof, embodiments of a color detection system and embodiments of methods for color detection in a color detection system, such as for the visually impaired, embodying features, principles, and concepts to detect color will be described. The visually impaired can include the blind, individuals with poor eyesight, the colorblind, and individuals who have a form of disability that prevents them from identifying a type or range of colors, for example. The various embodiments are shown for illustrative purposes and should not be construed in a limiting sense, and are not limited to the illustrations shown.

FIG. 1 illustrates an embodiment of a color detection system 100, such as for the visually impaired. The color detection system 100 can be a computer implemented device, and can be analog or digital, or both, such as can include optical sensors, a control unit, converters, a central processing unit, and memory. Also, it should be understood that the color detection system 100 can include or be implemented by, for example, a control unit, a processor, a computer, a tablet, a portable device, or a cellular phone, for example.

Embodiments of a color detection system, such as the color detection system 100 include at least one sensor, such as an optical sensor 102, and a control unit 130, for example. The control unit 130 includes a converter 104, a memory 108, a central processing unit 106, an audio memory 110, a power source, such as a battery 126, and an output unit 112, for example. The output unit 112 can include a plurality of sensory output units, such as an audio signal output unit 116, a vibration output unit 118, and a voltage output unit 120, for example.

Information, such as data signals of at least one color detected, can be generated by and acquired from the optical sensor 102 and sent to the converter 104 to transform the data signals into a number or set of parameters, such as by decoding color corresponding to data signals into a set of parameters as by a parametric coding scheme, such as can be selectively determined by a user of the color detection system 100, for example. The color detection system 100 can deliver the raw parameters corresponding to the detected one or more colors to decode the detected colors so that a user of the color detection system, such as a visually impaired individual, can interpret or associate the name of the one or more colors “felt” by the raw parameter feedback, for example. The converter 104 can then transmit the transformed signal or signals to the central processing unit 106 for processing the at least one set of parameters.

The parameters that can be used to decode a color can include: Hue, Saturation and Brightness (HSB), Hue, Saturation and Lightness (HSL), Red, Green and Blue (RUB), Cyan, Magenta and Yellow (CMY), and Cyan, Magenta, Yellow and Black (CMYK), for example, and should not be construed in a limiting sense. Also, the set of parameters can correspond to a complete or substantially complete parameterization of a color space according to one or more of the above or other color models, such as one or more of a HSB, HSL, RGB, CMY or CMYK color model, for example. The central processing unit 106 of the control unit 130 can store the at least one set of parameters into a computer readable memory, such as the memory 108 and the audio memory 110, and can be any suitable type of computer readable and programmable memory.

After the central processing unit 106 stores the at least one set of parameters into memory, such as the memory 108 or the audio memory 110, the central processing unit 106 can process the at least one set of parameters and determine therefrom at least one type of biofeedback, the at least one type of biofeedback can be determined based upon a predetermined criteria or correlation table, for example, such as can be stored in the memory 108 or the audio memory 110, and can transform the at least one set of parameters into the determined biofeedback and transmit the determined biofeedback to the output unit 112 to produce a type of sensory output as selected by the visually impaired individual.

Various types of sensory output can include and be provided by, for example, the audio signal output unit 116 which can produce audio pitches or frequencies of a certain or predetermined time duration or intensity, the vibration output unit 118 which can produce vibrations of a certain or predetermined time duration, intensity or frequency, and the voltage output unit 120 which can produce an electric shock or electric stimulus of a certain or predetermined time duration, intensity or voltage level, for example. The voltage can also be applied through external contact to a portion of a body, subcutaneous implanted electrodes or other internal electrode implants.

Embodiments of apparatuses of the color detection system for the visually impaired and methods for operating the color detection system for the visually impaired can also include for the control unit 106 to use a combination of the sensory output units, or other sensory output units, and is not limited in this regard. For example, embodiments of a color detection system can also have signals corresponding to colors output by pins above a surface, e.g., such as a pinboard displaying a representation of the color detected. Embodiments of a color detection system can also read or present colors via a reading pin using rotating rings as controls. Also, embodiments of a color detection system can also display or provide the signal corresponding to a color detected in Braille form or a variation thereof.

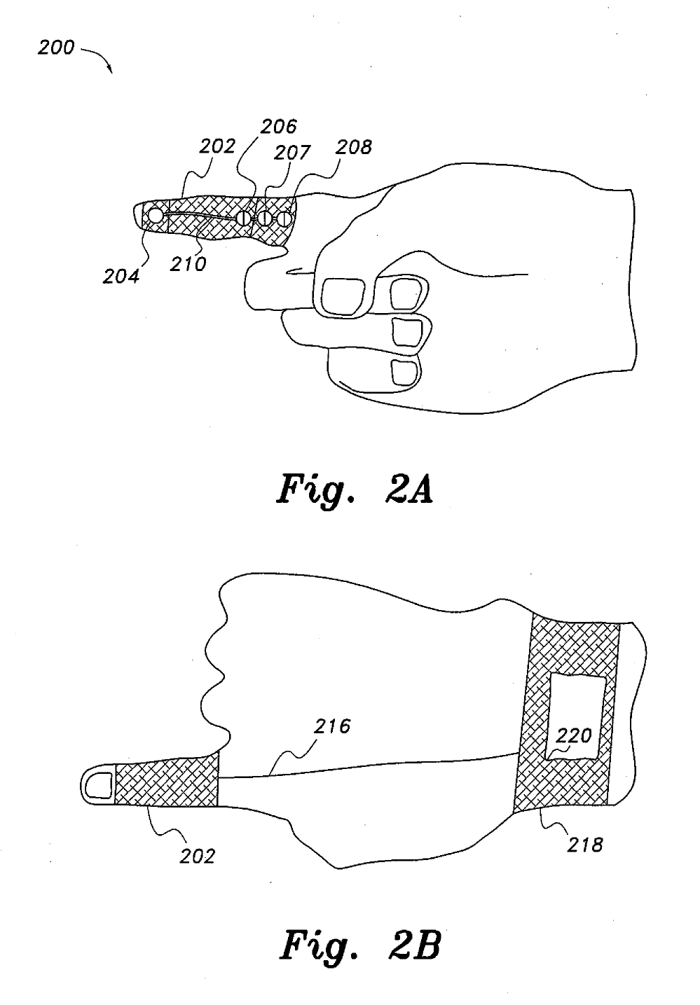

Referring now to FIG. 2A and FIG. 2B, there is illustrated an embodiment of the color detection system 200, such as for the visually impaired, in the form of a cover, such as a finger cover, associated with at least one finger of a hand of a user of the color detection system 200 attached to a wrist strap with a control unit 220 embedded or integrated with the color detection system 200.

FIG. 2A illustrates a front, palm view of the flexible, wearable finger cover 202 which includes at least one optical sensor 204 and output units 206, 207, and 208. FIG. 2B illustrates a back view of the finger cover 202 having the at least one optical sensor 204 and the output units 206, 207, and 208 connected by a flexible wire 216 to the control unit 220 connected to a wrist strap 218. The at least one optical sensor 204 and the output units 206, 207, and 208 can be also wired or wirelessly connected to the control unit 220, such as by a wired or a wireless transmitter/receiver, for example. In FIG. 2A and FIG. 2B, the finger cover 202 can be a fabric cover of a finger and can be connected by a flexible wire, such as the flexible wire 216, to the wrist strap 218, such as a fabric wrist strap, but the type or kind of material for the finger cover 202 and the wrist strap 218 is not limited in this regard and can be any type of suitable material.

The at least one optical sensor 204 can be any of various types of optical sensors, such as photoelectric sensors, for example. The output units 206, 207, and 208 can be used as an actuator and can be any of the various types of actuators, such as an electric actuator, for example. The at least one optical sensor 204 and the output units, 206, 207, and 208 are connected by a wire 210 embedded in the finger cover 202 that is connected to a flexible wire or cable, such as the flexible wire 216 to be communicatively connected to the control unit 220. Also, the at least one optical sensor 204 and the output units 206, 207, and 208 can also be integrated with a wireless transmitter/receiver to be communicatively connected to the control unit 220.

The control unit 220 is similar to the control unit 130 and can include a converter, a central processing unit, a memory, an audio memory, a power source, such as a battery as can be associated with or hosted by the control unit 220, and an output unit further including at least an audio output unit, such as described for the output unit 112 of the control unit 130 of FIG. 1. In this embodiment a voltage output unit and a vibration output unit can be the output units 206, 207, and 208 for producing a vibration of a certain or predetermined time duration or intensity and a voltage signal or electric shock or electrical stimulus of a certain or predetermined time duration or intensity, but is not limited in this regard and can be included in the control unit 220.

The at least one optical sensor 204 can initially detect at least one color and transmit data signals of the at least one color through the flexible wire 216 to the converter, similar to the converter 104, in the control unit 220. The converter can then transform the data signals into a set of parameters to be sent to a central processing unit, similar to the central processing unit 106, in the control unit 220. The central processing unit in the control unit 220 analyzes the at least one set of parameters received from the converter and determines from the at last one set of parameters at least one type of biofeedback and transforms the at least one set of parameters into the determined at least one type of biofeedback to the visually impaired individual using the color detection system 200, such as an audio frequency pitch of a certain or predetermined time duration or intensity, a vibration of a certain or predetermined time duration or intensity, or a voltage signal, shock or electrical stimulus of a certain or predetermined time duration or intensity, for example.

The central processing unit of the control unit 220, such as the central processing unit 106, can transmit the at least one type of biofeedback to an output unit, such as illustrated in output unit 112 or output units 206, 207, and 208, for producing the sensory output as selected by the visually impaired individual, such as producing an audio pitch of a certain or predetermined time duration or intensity from the audio signal output unit, such as from the audio signal output unit 116 or producing a vibration of a certain or predetermined time duration or intensity and a voltage signal or electric shock or electrical stimulus of a certain or predetermined time duration or intensity, such as from the output units 206, 207, and 208 located in the finger cover 202, for example.

The following example illustrates using the finger cover 202 in the color detection system 200 and should not be construed in a limiting sense. The finger cover 202 of the color detection system 200 can also be implemented as to cover an entire finger or a portion of a finger, such as a finger insert of a number of straps on or around the fingertips, or a combination thereof, equipped with a sensor, such as the at least one optical sensor 204. To use the finger cover 202, the user can simply touch at least one sensor, such as the at least one optical sensor 204 at the tip of the finger cover 202, to the object the user desires to know the color of the object. The tip of the finger cover 202 is equipped with at least one optical sensor, for example, but is not limited in this regard and additional sensors can be added. Additionally, the at least one optical sensor can be placed in a number of locations on the finger cover 202 and is not limited in this regard.

The at least one sensor, such as the at least one optical sensor 204, can detect the color and generate and transmit the data signals of at least one color to the converter inside the control unit 220. The converter can transform the data signals of at the least one color into a number or set of parameters. The converter implements a program or method of decoding the at least one color into a set of parameters as by a parametric coding scheme as to simulate the complexity of a number of colors.

The converter of the control unit 220 can then transmit the converted set of parameters to the central processing unit. The central processing unit can transform the at least one set of parameters received from the converter into at least one type of biofeedback to the visually impaired individual, as described, for example. The at least one type of biofeedback can be in the form of various sensory outputs such as an audio frequency pitch, a vibration intensity, a voltage signal, an electrical shock or an electrical stimulus, for example. In this regard, the biofeedback signal can be delivered to the skin of a finger of a user of the finger cover 202, for example.

The central processing unit of the control unit 220, such as the central processing unit 106, then sends the at least one type of biofeedback to an output unit, such as the output unit 112, to produce the at least one type of biofeedback from a sensory output unit, such as the audio signal output unit 116. The central processing unit of the control unit 220, such as the central processing unit 106, can also send the at least one type of biofeedback, such as vibrations or voltage signals, to the output units 206, 207, and 208 located in the finger cover 202 to produce the at least one type of biofeedback.

The color notification and sensory association can be a number of sensory outputs and additional sensory outputs can be added. Therefore, the sensory output unit, such as the output unit 112, of the color detection system 200 can assist the visually impaired individual to perceive a color with a physical, emotional, or cognitive association, for example.

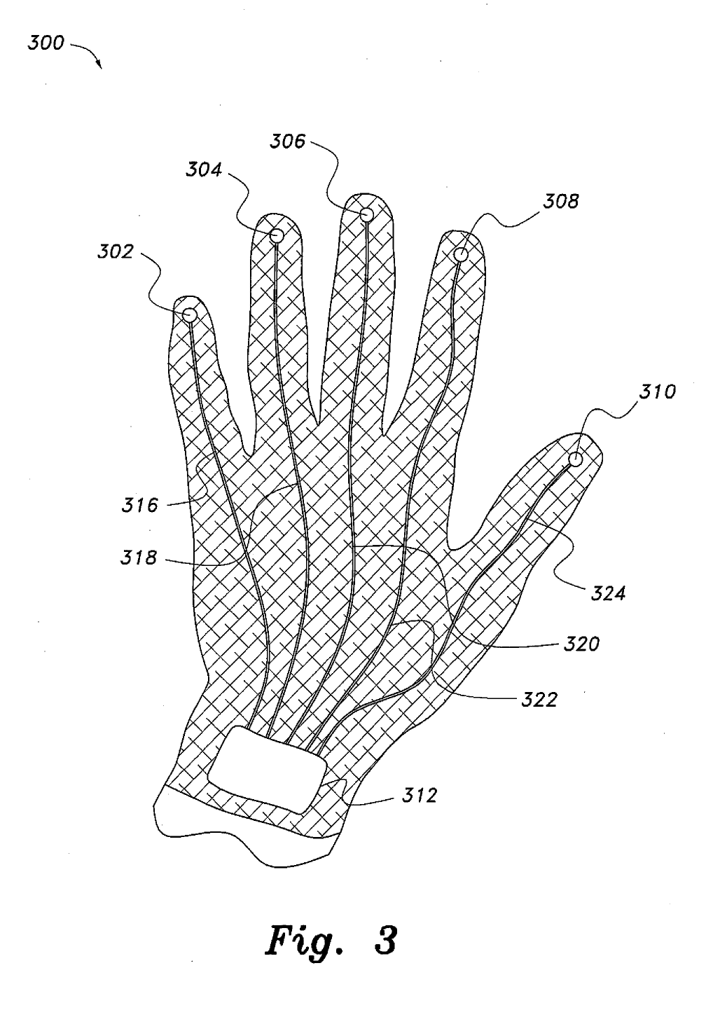

Referring now to FIG. 3, there is illustrated an embodiment of a color detection system 300 for the visually impaired in the form of a cover, such as a color detecting glove. The color detecting glove's main body can be a type of fabric, but is not limited in this regard and can be any type of suitable material, such as cloth, plastic, fabric, latex, vinyl, or a combination thereof, for example.

FIG. 3 illustrates a front, palm view of the color detecting glove associated with the hand of a user of the color detecting system 300 with optical sensors at the tip of each finger, such as optical sensors 302, 304, 306, 308, and 310. Each optical sensor is connected by a flexible wire, such as flexible wires 316, 318, 320, 322, and 324, to a control unit 312, similar to the control unit 130 of FIG. 1, or the optical sensors 302, 304, 306, 308, and 310 can be connected to a wireless transmitter/receiver to be communicatively connected to the control unit 312. Also, optical sensors 302, 304, 306, 308, and 310 can be integrated with a wireless transmitter/receiver for communication with the control unit 312, for example, and should not be construed in a limiting sense.

The optical sensors 302, 304, 306, 308 and 310 initially detect at least one color and generate and transmit the data signals of at least one color through the flexible wires 316, 318, 320, 322, and 324, or through a wireless transmitted/receiver, to the converter, such as the converter 104, in the control unit 312. The converter can then transform the data signals of at least one color into at least one set of parameters to be sent to a central processing unit, such as the central processing unit 106, in the control unit 312. The central processing unit in the control unit 312 analyzes and processes the at least one set of parameters received from the converter to determine therefrom at least one type of biofeedback and transforms the at least one set of parameters into the determined at least one type of biofeedback to provide to the visually impaired individual using the color detection system 300, such as an audio frequency pitch of a certain or predetermined time duration or intensity, a vibration of a certain or predetermined time duration or intensity, or a voltage signal, shock or electrical stimulus of a certain or predetermined time duration or intensity, for example. At least one type of biofeedback can be produced back through at least one of the flexible wires, 316, 318, 320, 322, and 324, such as a voltage shock from one of the flexible wires.

Also, in embodiments of the color detection system 300, a user can also enable the control unit 312 to selectively turn off one or more biofeedback signals, such as received through one or more of the optical sensors 302, 304, 306, 308 and 310, such as for detection of black and white colors as can correspond to a black and white image or to “view” a color image as a black and white image, and desirably can use a plurality of optical sensors, such as a plurality of the optical sensors 302, 304, 306, 308 and 310 on a corresponding plurality of fingers, to appreciate such black and white image, for example, using the color detection system 300.

The central processing unit can determine and transmit the at least one type of biofeedback to the output unit, such as illustrated in the output unit 112, for producing the sensory output as selected by the visually impaired individual, such as producing an audio pitch of a certain or predetermined time duration or intensity from the audio signal output unit, such as the audio signal output unit 116, a vibration of a certain or predetermined time duration or intensity from the vibration output unit, such as the vibration output unit 118, and a voltage signal, electric shock or electrical stimulus of a certain or predetermined time duration or intensity from the voltage output unit, such as the voltage output unit 120, for example.

The color notification and sensory association can be a number of sensory outputs and additional sensory outputs can be added, for example. The color notification and sensory output units can also include for delivery or producing in another location other than the control unit 312, such as a vibration output unit 118 being located on at least one finger of the color detecting glove. Therefore, the sensory output unit of the color detection system 300 can assist the visually impaired individual to perceive a color with a physical, emotional, or cognitive association, for example.

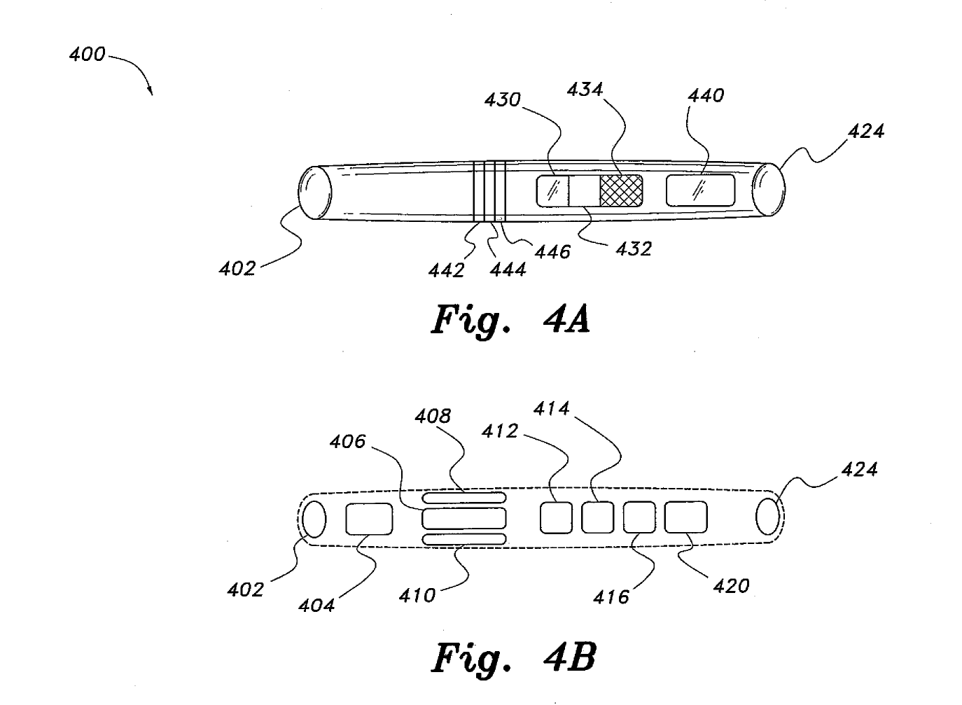

Referring now to FIG. 4A and FIG. 4B, there is illustrated an embodiment of the color detection system 400 for the visually impaired in the form of a digital pen. The digital pen body can be formed of a type of plastic, but is not limited in this regard and can be any type of suitable material, such as plastic, metal, wood, stone, or a combination thereof, for example.

FIG. 4A illustrates an exterior view of the digital pen of the color detection system 400. The exterior view of the digital pen of the color detection system 400 illustrates an optical sensor 402, a number of rotating rings 442, 444, and 446, a power switch 440, a voltage output exterior member 430, such as an electrode type member to generate and transmit an electrical voltage, shock or electrical stimulus, a vibration output exterior member 432, such as a piezoelectric member, to generate and transmit a vibration, an audio output exterior member 434, such as a speaker, to generate an audio sound, such as a pitch, and a digital output unit 424. FIG. 4B illustrates an interior view of the digital pen of the color detection system 400. The interior view of the digital pen of the color detection system 400 illustrates the optical sensor 402, a converter 404, a central processing unit 406, a memory 408, an audio memory 410, a voltage output unit 412, a vibration output unit 414, an audio signal output unit 416, a power source, such as a battery unit or a battery 420 to provide power to operate of the digital pen of the color detection system 400, and the digital output unit 424.

The following example illustrates using the digital pen of the color detection system 400 in FIG. 4A and FIG. 4B and should not be construed in a limiting sense. To begin using the digital pen of the color detection system 400 to detect at least one color a user can actuate the power switch 440 to activate the digital pen of the color detection system 400. The power switch 440 can also include various settings corresponding to a selection key to select one or more types of sensory feedback to be received by a user corresponding to a detected or a selected one or more colors corresponding to one or more set values of the parameters of the rotating rings 442, 444 and 446, such as three rotating rings, for example. A user can then touch or point the optical sensor 402 of the digital pen of the color detection system 400 to or toward the object to detect at least one color. The optical sensor 402 generates and sends the data signals of the color detected to the converter 404. The converter 404 transforms the data signals of the color detected into at least one set of parameters.

The converter 404 transforms the data signals of the at least one color detected into a set parameters as by a parametric coding scheme as to simulate the complexity of a number of colors. The converter can also transform the data signals of the at least one color detected into a set of parameters by the user manipulating the number of rotating rings 442, 444, and 446 to a desired configuration. The at least one set of parameters are sent by the converter 404 to the central processing unit 406. The central processing unit 406 analyzes the at least one set of parameters received from the converter 404, determines the at least one type of biofeedback from the at least one set of parameters and transforms the at least one set of parameters into the determined at least one type of biofeedback to the visually impaired individual using the color detection system 400.

The types of feedback, or combinations thereof can include an audio frequency pitch of a certain of predetermined time duration or intensity, such as provided by the audio output exterior member 434, a vibration of a certain or predetermined time duration or intensity, such as provided by the vibration output exterior member 432, or such as a voltage signal, shock or electrical stimulus of a certain or predetermined time duration or intensity, such as provided by the voltage output exterior member 430, for example. The central processing unit 406 can store the at least one type of biofeedback into the memory 408, such as for the voltage or vibration biofeedback, or into the audio memory 410, such as for the audio frequency biofeedback, for example.

The central processing unit 406 can then transmit the at least one type of biofeedback to a number of sensory output units for producing the sensory output as selected by the visually impaired individual, such as producing an audio pitch of a certain or predetermined time duration or intensity from audio signal output unit 416 as provided to an output by the audio output exterior member 434, a vibration of certain or predetermined time duration or intensity from the vibration output unit 414, such as provided to and output by the vibration output exterior member 432, and a voltage signal or electric shock or electric stimulus of a certain or predetermined time duration or intensity from the voltage, output unit 412, such as provided to and output by the voltage output exterior member 430, for example.

In this embodiment of the color detection system 400, the digital pen of the color detection system 400 also includes the digital output unit 424. The central processing unit 406 can also transmit the color detected of an object from the optical sensor 402 to the digital output unit 424 with or without transforming the signals of the color detected into biofeedback. The digital output unit 424 can produce the color detected from the optical sensor 402 onto a surface adapted for digital ink or paint, such as touchscreens and computer tablets, or such as the digital pen of the color detection system 400 can include or be associated with an ink jet mixer to spray the detected or a selected color on a paper or canvas, for example. Therefore, the digital output unit 424 of the digital pen of the color detection system 400 can enable the visually impaired individual to obtain colors from a number of sources and generate art or artistic creations, for example.

The digital pen can include for the digital output unit to be external to the inner area of the digital pen. The digital pen can also include for the digital output unit to be internal to the digital pen and manipulated to become external to the digital pen. The digital pen can include for the number of rotating rings 442, 444 and 446, such as three rotating rings, to set the value of the parameters and is similar to manually setting the sound level of a radio but a combination of the number of rotating rings can be used to set or select the color or a parameterization of at least one color space to be displayed from or produced by the digital output unit, such as set by or selected by a visually impaired person or a trainer, such as selecting a color or the amount of red green and blue in a color, for example.

In addition to the rotating rings 442, 444 and 446, other various suitable mechanical mechanisms or arrangements can be used set the value of the parameters or to set the color to be displayed, such as one or more mechanical sliders, for example, and should not be construed in a limiting sense. The rotating rings can be manipulated manually, mechanically or by digital instruction. The plurality of rotating rings included on the digital pen can set at least one set of parameters to decode at least one color detected or selected to display from or to produce by the digital output unit. The one or more colors selected or detected to be displayed can be presented by a light emitting diode (LED) source, for example, or shown onto a surface adapted for digital ink or paint, such as touchscreens and computer tablets, for example.

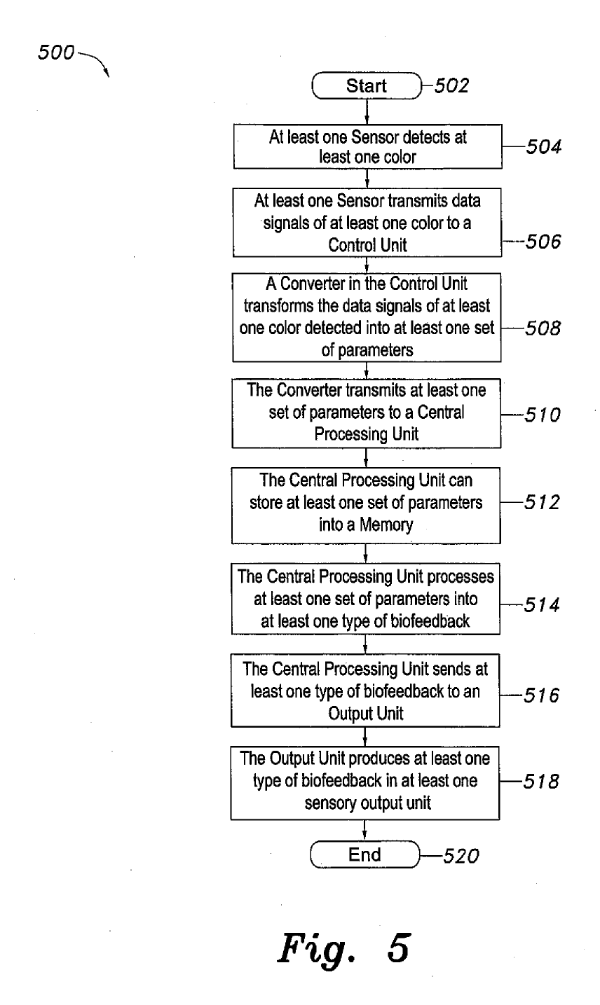

Referring now to FIG. 5, there is illustrated a flowchart of a logic tree 500 of an embodiment of a method for color detection in a color detection system, such as using the color detection system 100 of FIG. 1, or such as using the color detection systems 200, 300 and 400 of FIGS. 2A, 2B, 3, 4A and 4B, is illustrated and described schematically. In the flowchart of the logic tree 500, at step 502, the color detection system starts and can be initiated, such as by the power switch 440 of the digital pen in FIG. 4A, or the color detection system can be in an inactive or a passive mode until an optical sensor, such as the optical sensor 204 of the finger cover 202 in FIG. 2A and the optical sensor 308 of the color detecting glove in FIG. 3, touches an object to detect at least one color, for example.

At step 504, at least one sensor, such as the optical sensor 204, the optical sensor 308, or the optical sensor 402, for example, detects at least one color. The at least one sensor transmits data signals of the at least one color to a control unit, such as the control unit 130 or the control unit 220, at step 506. A converter, such as the converter 104, transforms the data signals of the at least one color detected into at least one set of parameters at step 508. At step 510, the converter, such as the converter 104, transmits the at least one set of parameters to a central processing unit, such as the central processing unit 106. The central processing unit, such as the central processing unit 106, can then store the at least one set of parameters into a memory, such as one or more of the memory 108 and the audio memory 110, at step 512.

At step 514, the central processing unit, such as the central processing unit 106, processes the at least one set of parameters into at least one type of biofeedback. Also, at step 514 the at least one type of biofeedback can include an audio frequency pitch of a certain or predetermined time duration or intensity, a vibration of a certain or predetermined time duration or intensity, or a voltage signal, an electrical shock or an electrical stimulus of a certain or predetermined time duration or intensity, or combinations thereof, for example, but is not limited in this regard and additional sensory outputs can be added, for example. Continuing at step 516, the central processing unit sends the at least one type of biofeedback to an output unit, such as the output unit 112.

At step 518, the output unit, such as the output unit 112, produces at least one type of biofeedback, such as in a user selected sensory output unit, such as the audio signal output unit 116 which can produce audio pitches of a certain or predetermined time duration or intensity, the vibration output unit 118 which can produce vibrations of a certain predetermined time duration or intensity, and the voltage output unit 120 which can produce a voltage signal, an electric shock or an electric stimulus of a certain or predetermined time duration or intensity, or combinations thereof, for example. The at least one type of biofeedback, such as produced by the output unit 112, can produce the biofeedback singularly, simultaneously, or in any combination thereof. At step 520, the described embodiment of a method for color detection in a color detection system ends, and embodiments of the color detection system can then be deactivated or return to an inactive or a passive power mode until at least one sensor of a color detection system, such as the optical sensor 204, touches or is directed at an object.

Embodiments of color detection systems and the methods for color detection in color detection systems can be implemented through the use of one or more sensor apparatuses, memories, processors, and output units, for example. In embodiments of a color detection system, apparatuses, and methods for color detection in a color detection system, at least one sensor can also be a photodetector, an ultrasonic sensor, a chromaticity sensor, a pyrometer, an intelligent sensor, or a variation thereof, and is not limited in this regard. Embodiments of a color detection system, apparatuses, and methods for color detection in a color detection system can also include or provide for the biofeedback to be produced at or around different parts of the body of an individual, for example. Further, embodiments of a color detection system can include for the user to choose the parametric coding scheme as transformed by the converter, such as the converter 104, for example.

While multiple sensory output units are shown, embodiments of color detection systems are not limited in this regard and can be a single sensory output unit or include a plurality of sensory output units, such as for audio pitches, audio frequencies, vibrations, and voltage signals, electrical shocks or electrical stimuli, for example. Furthermore, the types of biofeedback can be, as described, audio pitches of a certain or predetermined time duration or intensity, a vibration of a certain or predetermined or time duration or intensity, and a voltage signal, an electrical shock or an electrical stimulus of a certain or predetermined time duration or intensity. However, the types of biofeedback in embodiments of color detection systems are not limited in this regard and additional biofeedback or types of biofeedback, such as thermal change, olfactory, or other tactile responses can be produced, as well, for example.

Also, embodiments of a color detection system, apparatuses, and methods for color detection in a color detection system can also include the control unit providing a set of parameters or a monochromatic, single parameter with a number of reduction schemes, for example, and should not be construed in a limiting sense. Additional various embodiments of a color detection system, apparatuses, and method for color detection can also include a control switch for the user to turn off at least one type of biofeedback. Other embodiments of a color detection system, apparatuses, and method for color detection can for the system, apparatus, and method to detect an image, such as a black and white image, and produce at least one type of biofeedback associated with the image detected.

Embodiments of a color detection system, apparatuses, and methods for color detection in a color detection system can include a device with a reading head for color detection, for example. The reading head can decode the color into a number of parameters and transmit the parameters to actuators, such as digital or analog actuators. The actuators can include a number of rings with tips, such as three rings with felt tips. A rotating actuator, such as a piezoelectric or an electromagnetic actuator, can rotate at least one ring into a number of positions in a range. The at least one ring can form a color selection and transmit the color selection to the actuator to produce the selected color, for example.

Various embodiments of a color detection system illustrate the optical sensor and the control unit as separate components, but embodiments of a color detection system are not limited in this regard and separate components can be included or integrated or integrally formed in or as a unit, as can be larger or smaller in size, such as in the digital pen of the color detection system 400 of FIG. 4A and FIG. 4B, for example. Additionally, embodiments of the digital pen of the color detection system 400 can include for the pen to include a digital output unit to write or paint on a variety of surfaces that are adaptable for digital ink or paint, such as touchscreens or tablets, or paper or canvas, for example. The digital output unit, such as of the digital pen of the color detection system 400, can include an electronic writing tip, paintbrush, laser pointer, or a variation thereof, for example. Additional embodiments of the digital pen of the color detection system 400 can also include the digital output unit to produce a number of colors based on actuating a digital color selection and controlling painting in computerized devices such as touchscreens or tablets or on a paper or canvas, for example.

It should be understood that the operations of embodiments of a color detection system can be performed by any suitable computer system, such as that diagrammatically shown in the drawing of the color detection system 100 of FIG. 1. Data entered into the control unit 130 via any suitable type of interface, such as the optical sensor 102, can be stored in a memory, such as the memory 108 or the audio memory 110, which can be any suitable type of computer readable and programmable memory and can be a non-transitory, computer readable medium. Operations are performed by a central processing unit, such as central processing unit 106, which can be any suitable type of computer processor and can be produced to the user of a color detection system on a sensory output unit, which can be any suitable type of sensory output unit, such as the output unit 112.

The central processing unit, such as the central processing unit 106, can be associated with, or incorporated into, any suitable type of computing device, for example, a personal computer, portable computing device, smartphone, or a programmable logic controller. The sensory output units, the central processing unit, the at least one memory and any associated computer readable recoding media are in communication with one another by any suitable type of system or data bus, for example.

Examples of computer readable memory as can be used or included in the memory 108 or the audio memory 110 can include a non-transitory computer readable storage memory, a magnetic recording apparatus, an optical disk, a magneto-optical disk, and/or a semiconductor memory (for example, RAM, ROM, etc.). Examples of magnetic recording apparatus that can be used in addition to or in place of the memory 108 or the audio memory 110 include a hard disk device (HDD), a flexible disk (FD), a magnetic tape (MT). Examples of the optical disk include types of DVDs (Digital Versatile Discs), DVD-RAMs, CD-ROMs (Compact Disk Read Only Memory), and CD-Rs (recordable)/RW.

The information and operations that are transmitted throughout the various embodiments of a color detection system, apparatuses of a color detection system and methods for color detection in a color detection system can be in the form electronic data, wired signals, wireless signals, or a variation thereof. The information and operations that are transmitted throughout the various embodiments can be sent, wirelessly, optically, or by any of various types of hard wire connections or combinations thereof, among various system or apparatus components, for example, of a color detection system. Embodiments of a color detection system, apparatuses of a color detection system and methods for color detection in a color detection system can include various power sources, such as batteries, such as the battery 420 of FIG. 4, or can be coupled to a charging device or connected or coupled to a standard outlet for electrical power, for example.

It should be noted by persons of ordinary skill in the art that equivalent replacements or variations of components or units with the same or similar property and purpose can be made in embodiments of a color detection system and, therefore, should not be construed in a limiting sense.

It is to be understood that the present invention is not limited to the embodiments described above, but encompasses any and all embodiments within the scope of the following claims.

I claim:

1. A color detection system for the visually impaired, comprising:
at least one sensor to detect at least one color and transmit data signals corresponding to the at least one color detected; and
a control unit to receive the data signals corresponding to the at least one color detected and to transform the received data signals into at least one set of parameters, the control unit including a converter, a central processing unit, at least one memory, and an output unit,
wherein the converter converts the received data signals into the at least one set of parameters, the central processing unit receives the at least one set of parameters from the converter and processes the at least one set of parameters into at least one type of biofeedback and transmits the at least one type of biofeedback to the output unit to output the at least one type of biofeedback to a user of the color detection system.

2. The color detection system for the visually impaired according to claim 1, wherein the output unit comprises a plurality of sensory output units to output the at least one type of biofeedback, the plurality of sensory output units including one or more of:
an audio signal output unit to produce at least one audio pitch of at least one of a predetermined time duration or intensity,
a vibration output unit to produce vibrations of at least one of a predetermined time duration or intensity, and
a voltage output unit to produce a voltage signal, an electric shock or an electric stimulus of at least one of a predetermined time duration or intensity.

3. The color detection system for the visually impaired according to claim 2, wherein the central processing unit stores the at least one set of parameters in the at least one memory.

4. The color detection system for the visually impaired according to claim 1, wherein the central processing unit stores the at least one set of parameters in the at least one memory.

5. The color detection system for the visually impaired according to claim 1, further comprising:
a finger cover including at least one sensor communicatively connected to the control unit.

6. The color detection system for the visually impaired according to claim 1, further comprising:
a glove including a plurality of sensors to detect the at least one color and to transmit data signals corresponding to the at least one color detected to the control unit, the plurality of sensors being communicatively connected to the control unit.

7. The color detection system for the visually impaired according to claim 1, further comprising:
a digital pen, the digital pen including the at least one sensor and the control unit and further including a digital output unit to produce the at least one color detected onto a surface.

8. The color detection system for the visually impaired according to claim 1, wherein a parametric coding transforms the received data signals into the at least one set of parameters to decode the at least one color detected.

9. An apparatus to detect color for the visually impaired, the apparatus comprising:
at least one sensor to detect at least one color, wherein the at least one sensor scans an area to detect the at least one color, generates data signals corresponding to the detected at least one color and transmits the data signals corresponding to the at least one color detected; and
a control unit communicatively connected to the at least one sensor to receive the data signals corresponding to the at least one color detected and to transform the received data signals into at least one set of parameters, the control unit including a converter, a central processing unit, at least one memory, and an output unit,
wherein the converter converts the received data signals into the at least one set of parameters, the central processing unit receives the at least one set of parameters from the converter and processes the at least one set of parameters into at least one type of biofeedback and transmits the at least one type of biofeedback to the output unit to output the at least one type of biofeedback to a user of the color detection system.

10. The apparatus to detect color for the visually impaired according to claim 9, wherein the output unit comprises a plurality of sensory output units to output the at least one type of biofeedback, the plurality of sensory output units including one or more of:
an audio signal output unit to produce audio pitches of at least one of a predetermined time duration or intensity,
a vibration output unit to produce vibrations of at least one of a predetermined time duration or intensity, and
a voltage output unit to produce a voltage signal, an electric shock or an electric stimulus of at least one of a predetermined time duration or intensity.

11. The apparatus to detect color for the visually impaired according to claim 9, wherein the central processing unit stores the at least one set of parameters into the at least one memory, the at least one set of parameters to decode the at least one color detected and including one or more of Hue, Saturation and Brightness (HSB), Hue, Saturation and Lightness (HSL), Red, Green and Blue (RGB), Cyan, Magenta and Yellow (CMY), Cyan, Magenta, Yellow and Black (CMYK), or combinations thereof.

12. The apparatus to detect color for the visually impaired according to claim 9, further comprising:
a flexible, wearable finger cover including at least one sensor; and
a wrist strap, the wrist strap including the control unit.

13. The apparatus to detect color for the visually impaired according to claim 9, further comprising:
a flexible, wearable glove including a plurality of sensors to detect at least one color and to transmit data signals corresponding to the at least one color detected to the control unit.

14. The apparatus to detect color for the visually impaired according to claim 9, further comprising:
a digital pen, the digital pen including the at least one sensor and the control unit and further including a digital output unit to produce the at least one color detected or to produce at least one color selected onto a surface; and
a plurality of rotating rings included on the digital pen to set the at least one set of parameters to decode the at least one color detected or selected to display from or to produce by the digital output unit.

15. A method for color detection in a color detection system, the method comprising the steps of:
scanning by at least one sensor an area to detect at least one color;
generating at least one data signal by the at least one sensor corresponding to the at least one color detected;
transmitting the at least one data signal corresponding to the at least one color detected to a converter;
transforming the at least one data signal by the converter into at least one set of parameters;
transmitting by the converter the at least one set of parameters corresponding to the at least one color detected to a central processing unit;
converting by the central processing unit the at least one set of parameters into at least one type of biofeedback;
transmitting by the central processing unit the at least one type of biofeedback to an output unit; and
providing by the output unit the at least one type of biofeedback corresponding to the at least one color detected to a user of the color detection system.

16. The method of claim 15, further comprising the step of:
producing at least one sensory output corresponding to the at least one type of biofeedback associated with the at least one color detected.

17. The method of claim 15, further comprising the step of:
producing at least one of one or more audio pitches of at least one of a predetermined time duration or intensity, one or more vibrations of at least one of a predetermined time duration or intensity, or one or more voltage signals, electric shocks or electric stimuli of at least one of a predetermined time duration or intensity corresponding to the at least one type of biofeedback associated with the at least one color detected.

18. The method of claim 15, further comprising the step of:
covering at least a portion of a hand with cover, the cover including at least one sensor to detect at least one color.

19. The method of claim 15, further comprising the step of:
incorporating the color detection system into a digital pen, the digital pen including the at least one sensor, the converter, the central processing unit and the output unit, the digital pen detecting the at least one color and selectively producing the at least one color detected onto a surface.

20. The method of claim 15, wherein a parametric coding transforms the at least one data signal into the at least one set of parameters to decode the at least one color detected.
